(19) United States
(12) Patent Application Publication
(10) Pub. No.: US 2017/0285899 A1
(43) Pub. Date: Oct. 5, 2017

(54) DISPLAY DEVICE AND COMPUTER-READABLE NON-TRANSITORY RECORDING MEDIUM WITH DISPLAY CONTROL PROGRAM RECORDED THEREON

(71) Applicant: KYOCERA Document Solutions Inc., Osaka (JP)

(72) Inventor: Suguru ISHIKAWA, Osaka (JP)

(73) Assignee: KYOCERA Document Solutions Inc., Osaka (JP)

(21) Appl. No.: 15/446,402

(22) Filed: Mar. 1, 2017

(30) Foreign Application Priority Data
Mar. 30, 2016 (JP) 2016-069365

(51) Int. Cl. G06F 3/0485; G06F 3/0484; G06F 3/0488

(52) U.S. Cl. CPC G06F 3/0485; G06F 3/04883; G06F 3/04845; G06F 2203/04804

(57) ABSTRACT

A display device includes a display, a display control section, a touch panel, a touch pressure detecting section, and a gesture acceptance section. The touch pressure detecting section detects a pressure of touch on the display. The display control section determines a scroll speed based on the pressure of touch detected by the touch pressure detecting section and, upon acceptance of a scroll gesture by the gesture acceptance section, allows the display to display a screen image by scrolling at the determined scroll speed.

### INCORPORATION BY REFERENCE

This application claims priority to Japanese Patent Application No. 2016-069365 filed on Mar. 30, 2016, the entire disclosure of which are incorporated herein by reference.

### BACKGROUND

The present disclosure relates to display devices and computer-readable non-transitory recording media with display control programs recorded thereon and particularly relates to a technique for scrolling a screen image displayed on a screen of a display.

Image forming apparatuses, mobile terminals, such as a smartphone, personal computers, and the like each includes a display, such as an LCD (liquid crystal display) or an OLED (organic light-emitting diode), and allows the display to display an image on its screen.

Because the display has limited area, it may not be able to display all parts of a screen image at a time. In this case, a part of the screen image is displayed and, upon acceptance of a user's scroll gesture, the screen image is displayed by scrolling.

### SUMMARY

A technique improved over the aforementioned technique is proposed as one aspect of the present disclosure.

A display device according to an aspect of the present disclosure includes a display, a touch panel, and a control unit. The touch panel is disposed at a front of the display and detects whether or not the display has been touched and a point of touch on the display. The control unit includes a processor and, based on operation of the processor in accordance with an operating program, accepts a scroll gesture on an image-displayed screen on which a screen image is displayed by the display, the scroll gesture being based on whether or not the display has been touched and the point of touch, which have been detected by the touch panel, and controls a display operation of the display. The control unit detects a pressure of touch on the display based on a signal output from the touch panel, determines a scroll speed based on the detected pressure of touch, and, upon acceptance of the scroll gesture, allows the display to display the screen image by scrolling at the determined scroll speed.

A computer-readable non-transitory recording medium according to another aspect of the present disclosure has a display control program recorded thereon, the display control program allowing a computer to function as a controller that accepts a scroll gesture on an image-displayed screen on which a screen image is displayed by a display, the scroll gesture being based on whether or not the display has been touched and a point of touch on the display, which have been detected by a touch panel disposed at a front of the display, and controls a display operation of the display. The display control program allows the computer to function so that the controller detects a pressure of touch on the display based on a signal output from the touch panel, determines a scroll speed based on the detected pressure of touch, and, upon acceptance of the scroll gesture, allows the display to display the screen image by scrolling at the determined scroll speed.

### BRIEF DESCRIPTION OF THE DRAWINGS

FIG. 1 is a block diagram showing an internal configuration of a display device according to one embodiment of the present disclosure.

FIG. 2 is a front view showing the appearance of the display device according to the one embodiment of the present disclosure.

FIG. 3 is a view showing an example of display target data displayed by the display device according to the one embodiment of the present disclosure.

FIGS. 4A and 4B are views showing an example of a screen image displayed by the display device according to the one embodiment of the present disclosure.

FIG. 5 is a flowchart showing a flow of a scrolling display operation of the display device according to the one embodiment of the present disclosure.

FIGS. 6A and 6B are views showing examples of a screen image displayed by the display device according to the one embodiment of the present disclosure.

FIG. 7 is a flowchart showing a flow of an operation of a display device according to a modification of the present disclosure.

FIG. 8 is a view showing an example of a screen image displayed by the display device according to the modification of the present disclosure.

### DETAILED DESCRIPTION

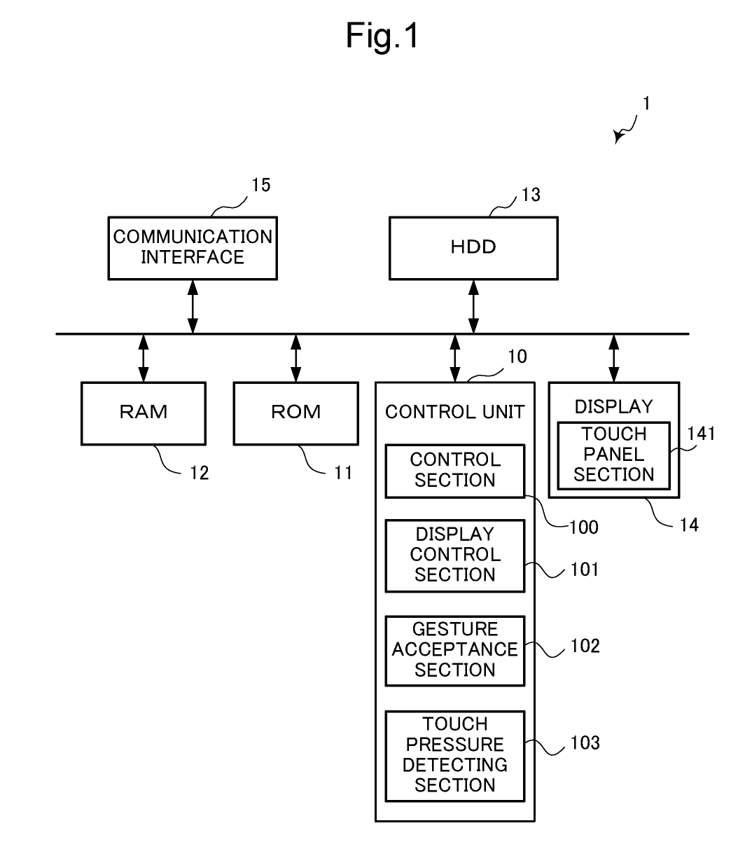

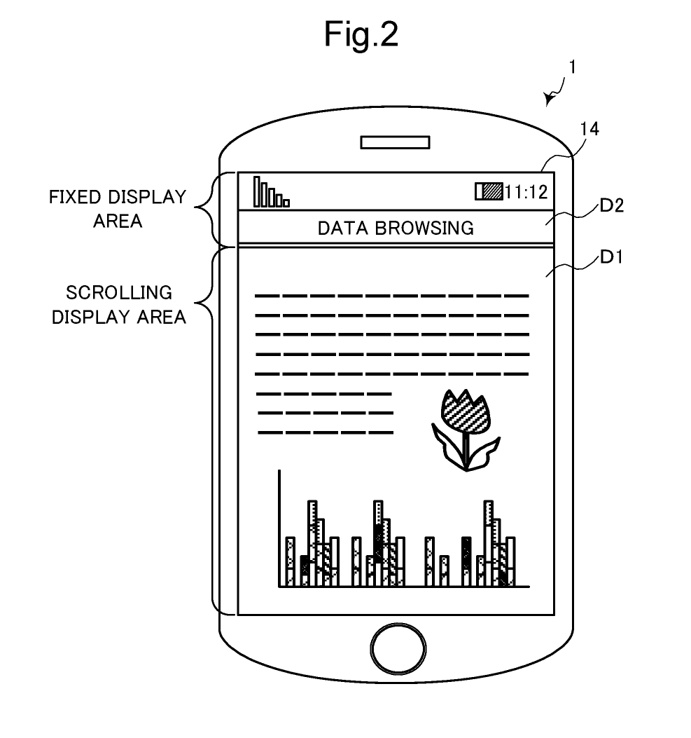

Hereinafter, a description will be given of a display device and a display control program, both according to one embodiment of the present disclosure, with reference to the drawings. FIG. 1 is a block diagram showing an internal configuration of the display device according to the one embodiment of the present disclosure. FIG. 2 is a front view showing the appearance of the display device according to the one embodiment of the present disclosure.

A display device 1 according to the one embodiment of the present disclosure is, for example, a mobile device such as a smartphone, and includes a control unit 10, a ROM 11, a RAM 12, an HDD 13, a display 14, and a communication interface 15. These components can transfer data or signals to and from one another via a CPU bus.

The control unit 10 includes a processor, such as a CPU (central processing unit), and governs the overall operation of the display device 1. The ROM 11 stores an operating program on basic operations of the display device 1. The RAM 12 is used as an operating region of the control unit 10 and for other purposes.

The HDD (hard disk drive) 13 stores, in part of its storage region, a display control program according to the one embodiment of the present disclosure. The control unit 10 operates in accordance with the display control program to function as a control section 100, a display control section 101, a gesture acceptance section 102, and a touch pressure detecting section 103. Alternatively, each of the control section 100, the display control section 101, the gesture acceptance section 102, and the touch pressure detecting section 103 of the control unit 10 may not be implemented by the operation in accordance with the display control program but may be constituted by a hardware circuit.

The communication interface 15 serves as an interface for data communication with personal computers and so on connected over a network.

The display 14 is formed of an LCD (liquid crystal display), an OLED (organic light-emitting diode) or the like and displays contents of various data and images showing operation guidance and the like for a user operating the display device 1.

A touch panel section 141 is provided at the front of the display 14. The touch panel section 141 is, for example, a resistive film touch panel and detects whether a user has touched an image-displayed screen of the display 14, together with a point of touch (coordinate point) on the screen. When detecting the user's touch, the touch panel section 141 outputs a detection signal indicating the point of touch to the gesture acceptance section 102 and so on. The touch panel section 141 encompasses a touch panel operable to detect a user's finger or the like when the user's finger or the like, even if not touching the image-displayed screen, comes within a certain small distance of the image-displayed screen. Therefore, the term “touch” used in this embodiment includes a state where a finger or the like coming within the certain small distance of the image-displayed screen is detected, without an actual touch on the image-displayed screen, by the function of the touch panel section 141, with the consideration of this state as a substantial touch.

As described previously, the control unit 10 includes the control section 100, the display control section 101, the gesture acceptance section 102, and the touch pressure detecting section 103.

The control section 100 governs the overall operation control of the display device 1. For example, when a user's instruction to send a mail is accepted by the gesture acceptance section 102, the control section 100 performs data communication with a mail server using the communication interface 15.

The gesture acceptance section 102 identifies a user's gesture entered by a user, based on a detection signal output from the touch panel section 141. Then, the gesture acceptance section 102 accepts the identified user's gesture and outputs a control signal corresponding to the user's gesture to the display control section 101 and so on.

In this relation, user's gestures include a scroll gesture (referred to also as a swipe gesture), a select gesture (referred to also as a tap gesture), and a pinch gesture. For example, when the user slides his/her finger on an image-displayed screen of the display 14 while keeping it in touch with the image-displayed screen, the touch panel section 14 outputs to the gesture acceptance section 102 detection signals indicating a series of points of movement from an initial point at which the touch has been first detected to a latest position at which the touch is last detected. The gesture acceptance section 102 identifies, based on the detection signals output from the touch panel section 141, a user's gesture entered by the user as a scroll gesture. Then, the gesture acceptance section 102 outputs a control signal corresponding to the scroll gesture to the control section 100, the display control section 101, and so on.

The display control section 101 has a function to control the display operation of the display 14 based on a user's gesture accepted by the gesture acceptance section 102. For example, when the gesture acceptance section 102 accepts a scroll gesture, the display control section 101 allows a screen image displayed on a screen of the display 14 to be displayed by scrolling according to the scroll gesture.

As shown in FIG. 2, a display area of the screen of the display 14 where data can be displayed includes a fixed display area and a scrolling display area. Display target data D1 to be displayed by scrolling according to a scroll gesture is displayed in the scrolling display area, while predefined data D2 is displayed in the fixed display area.

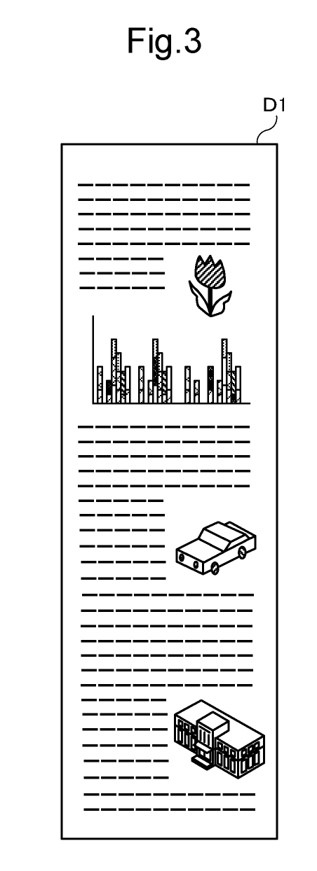

Because the display 14 has limited size, it cannot display all parts of the display target data D1 (see FIG. 3) within the scrolling display area at a time. Therefore, in the example shown in FIG. 2, the display control section 101 allows the display 14 to display a part of the display target data D1 as a screen image in the scrolling display area. When the gesture acceptance section 102 accepts a user's scroll gesture, the display control section 101 scrolls the screen image displayed in the scrolling display area.

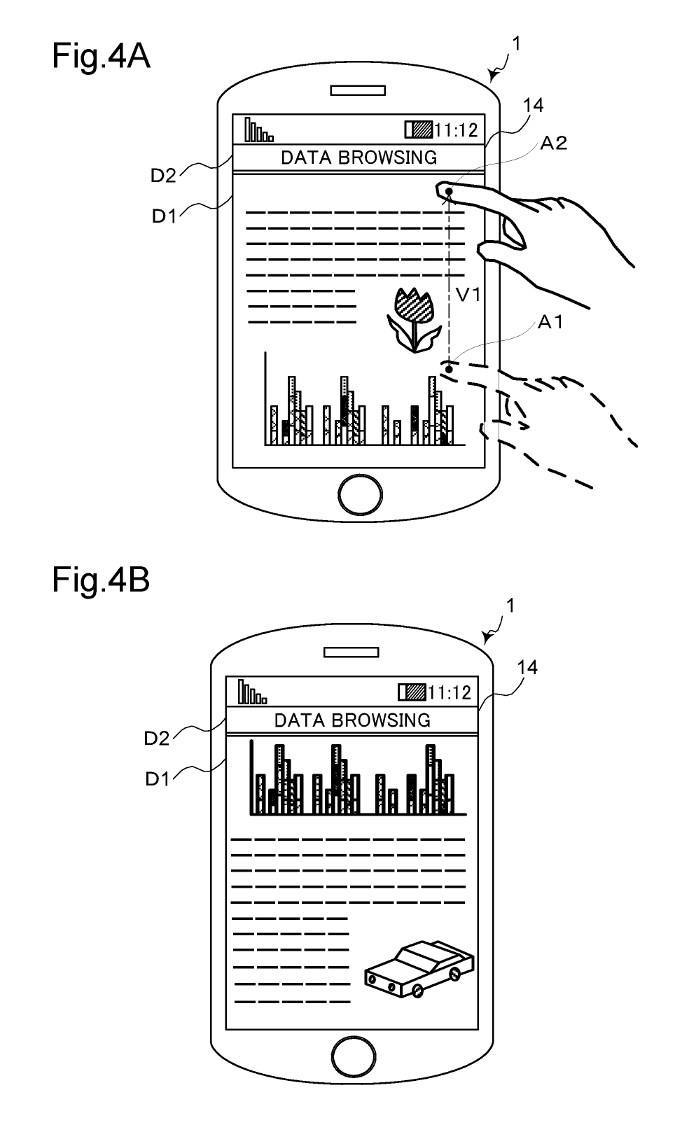

As in the example shown in FIG. 4A, when the user slides his/her index finger from point A1 and then stops the sliding movement at a certain point A2, the gesture acceptance section 102 identifies, based on detection signals output from the touch panel section 141, the acceptance of a scroll gesture. Then, the display control section 101 calculates a speed V2 (=N₀×V1) by multiplying a speed V1 of change in point of touch by a predetermined proportional constant N₀ and determines the calculated speed V2 as a scroll speed at which the screen image is displayed by scrolling. As a result of a scrolling display of the screen image at the speed V2, an image shown in FIG. 4B is displayed on the screen of the display 14.

Although details will be given later, the display device 1 according to the one embodiment of the present disclosure changes the above proportional constant depending on the pressure of touch on the display 14. Changing the force with which the user touches the display 14 with his/her finger or the like in the above manner enables the control of the setting of the scroll speed.

Referring back to FIG. 1, the touch pressure detecting section 103 has a function to detect the pressure of touch on the display 14 based on a signal output from the touch panel section 141. The touch pressure detecting section 103 outputs information on the detected pressure of touch to the display control section 101 and so on.

When the touch panel section 141 is a resistive film touch panel, the resistance to touch between a pair of resistive films forming the touch panel section 141 varies depending on the pressure of touch. Therefore, the touch pressure detecting section 103 calculates the pressure of touch based on the resistance to touch between the resistive films.

On the other hand, when the touch panel section 141 is a touch panel other than the resistive film touch panel, such as a capacitive touch panel, the display device 1 according to the one embodiment of the present disclosure is designed so that an unshown force sensor is disposed at the back of the display 14. In this case, the touch pressure detecting section 103 calculates the pressure of touch based on a signal output from the force sensor.

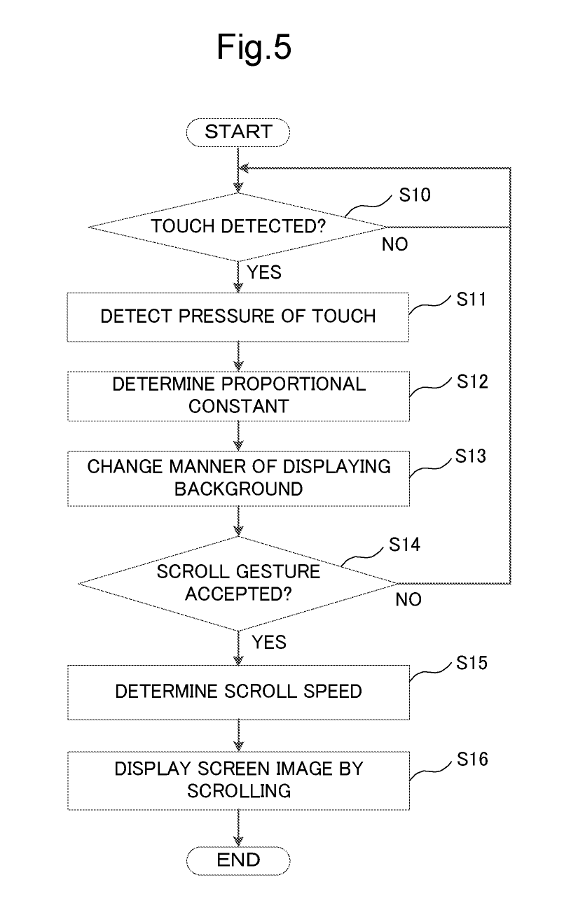

Next, a description will be given of an operation of the display device 1 having the above configuration. FIG. 5 is a flowchart showing a flow of a scrolling display operation of the display device 1.

When the gesture acceptance section 102 detects a touch on the display 14 (YES in step S10), the touch pressure detecting section 103 detects a pressure of touch on the display 14 (step S11).

The display control section 101 determines, based on the pressure of touch detected in step S11, a proportional constant for use in calculating the scroll speed (step S12). Specifically, the display control section 101 decreases the proportional constant as the pressure of touch increases. In other words, the display control section 101 changes the setting of the proportional constant so that the scroll speed of the screen image becomes lower as the pressure of touch increases.

After the stage of processing in step S12, based on the determined scroll speed, the display control section 101 allows the display 14 to change the manner of displaying a background of the image-displayed screen (step S13).

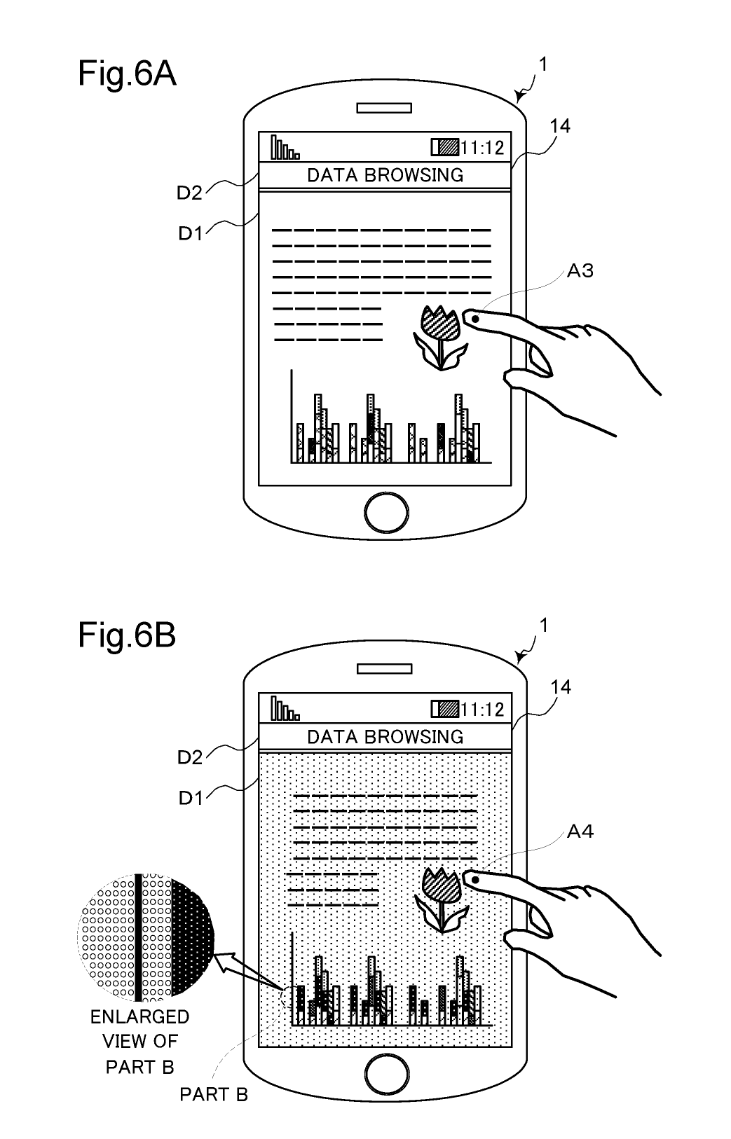

FIG. 6A is a view showing an example of a screen image displayed on the display 14 when the pressure of touch is low, i.e., the scroll speed is high, and FIG. 6B is a view showing an example of a screen image displayed on the display 14 when the pressure of touch is high, i.e., the scroll speed is low. As shown in these figures, the display control section 101 changes the background of the image-displayed screen so that the background can be seen to have a rougher texture as the scroll speed decreases. Specifically, the display control section 101 gives noise to the background of the image-displayed screen, thus changing the background so that it is seen to have a rough texture (see an enlarged view of Part B in FIG. 6B). As the pressure of touch on the display 14 increases, that is, as the scroll speed decreases, the display control section 101 increases the amount of noise given to the background.

Changing the manner of displaying the background of the image-displayed screen based on the scroll speed in this manner enables the user to be given an approximation of the scroll speed. For example, if the background of the image-displayed screen is changed so that it can be seen to have a rough texture, it can be known to the user that the scroll speed is low. On the other hand, if the background of the image-displayed screen is changed so that it can be seen to have a smooth texture, it can be known to the user that the scroll speed is high.

Referring back to FIG. 5, when the touch gesture detected in step S10 is kept uncanceled and the gesture acceptance section 102 then detects a scroll gesture on the display 14 (YES in step S14), the display control section 101 determines the scroll speed by multiplying the speed of change in point of touch during the scroll gesture by the proportional constant determined in the stage of processing in step S12 (step S15). Then, the display control section 101 allows the display 14 to display the screen image by scrolling at the determined scroll speed (step S16). On the other hand, when the touch gesture detected in step S10 is cancelled before a scroll gesture is detected in the stage of processing in step S14, the display control section 101 cancels the proportional constant determined in the stage of processing in step S12. Furthermore, the display control section 101 allows the display 14 to turn back the manner of displaying the background of the image-displayed screen, which has been changed in the stage of processing in step S13.

The suitable speed (scroll speed) in displaying the screen image by scrolling varies depending on the user and the type of usage. For example, some users may want to scroll the screen image at high speed, while others may want to scroll the screen image at low speed. Furthermore, if the user wants to confirm a wide range of screen image in a short time, it is preferred to scroll the screen image at high speed.

A display device is generally known which can change the scroll speed on a predetermined setting screen. However, the display device requires to call up the setting screen at every change of the scroll speed, which is bothersome and non-user-friendly.

Unlike the above, in the display device 1 according to the one embodiment of the present disclosure, as described previously, the scroll speed is determined based on the pressure of touch detected by the touch pressure detecting section 103. Thus, the user can change the scroll speed to a desired speed without calling up a predetermined setting screen.

The present disclosure is not limited to the configuration of the above embodiment and can be modified in various ways.

<Modification 1>

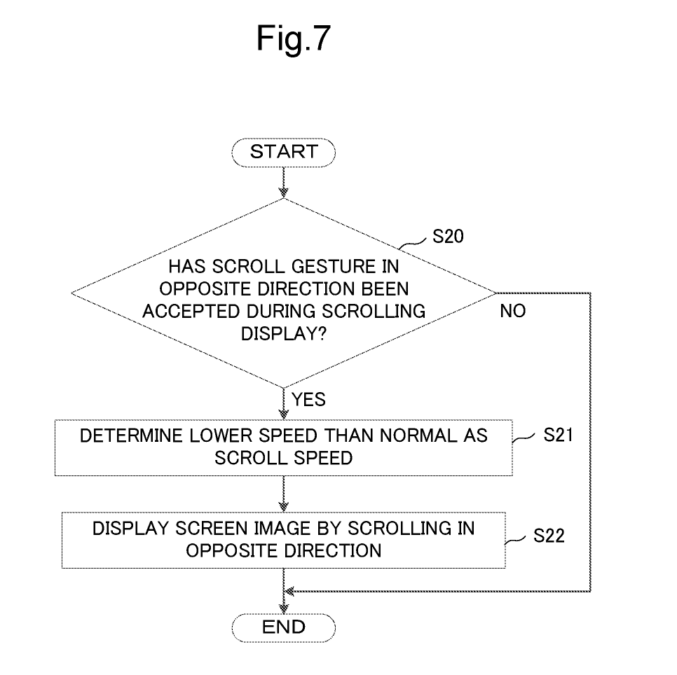

FIG. 7 is a flowchart showing a flow of an operation of a display device according to Modification 1.

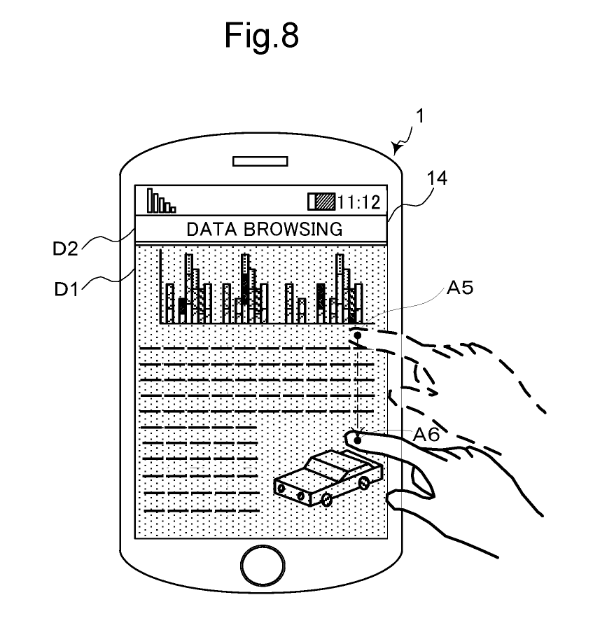

Consideration will now be given to the case that while, as shown in FIG. 4A, the display control section 101 displays a screen image by scrolling it downward in the plane of the figure (in a first direction) by a slide gesture upward in the plane of the figure from point A1 toward point A2, an instruction to display the screen image by scrolling it upward in the plane of the figure (in a second direction) is input by a slide gesture downward in the plane of the figure from point A5 toward point A6 as shown in FIG. 8.

When such a slide gesture is made in a general display device, the screen image is displayed by scrolling upward in the plane of the figure at a normal scroll speed (a scroll speed specified by a scroll gesture).

Unlike the above, in the display device according to Modification 1, in the case where while the display control section 101 allows the screen image to be displayed by scrolling in the first direction, the gesture acceptance section 102 accepts a scroll gesture for displaying the screen image by scrolling in the second direction (YES in step S20), the display control section 101 performs stages of processing in steps S21 and S22.

Specifically, the display control section 101 determines as the scroll speed a lower speed than a normal scroll speed specified by a scroll gesture (step S21) and allows the display 14 to display the screen image by scrolling upward in the plane of the figure at the determined scroll speed (step S22).

Furthermore, in doing so, the display control section 101 makes the manner of displaying the background during scrolling of the screen image in the second direction different from the manner of displaying the background during scrolling of the screen image in the first direction. In the example shown in FIG. 8, the display control section 101 changes the background of the image-displayed screen so that the background can be seen to have a rough texture. Thus, it can be known to the user that the scroll speed is low.

In many cases, a scroll gesture in the opposite direction is a gesture made when the user misses information contained in a screen image being scrolled and wants to check the missed information. In the display device according to Modification 1, scrolling display very likely to be performed when the user checks missed information is provided at a lower speed than a normal scroll speed specified by a scroll gesture. Therefore, the user can easily check missed information.

<Modification 2>

Although in the above embodiment the case where noise is given to the background has been described as an example where the manner of displaying the background of the image-displayed screen is changed based on the scroll speed, the present disclosure is not necessarily limited to this case.

In a display device according to Modification 2, the display control section 101 changes the color of the background of the image-displayed screen based on the scroll speed. Specifically, the display control section 101 changes the density of the color of the background and increases the color density as the scroll speed decreases. The display device according to Modification 2 can give the user an approximation of the scroll speed by changing the density of the color of the background in the above manner.

<Other Modifications>

For example, although the above embodiment shows the display device 1 which is a mobile device, such as a smartphone, taken as an example of the display device according to the present disclosure, the present disclosure is not necessarily limited to this case. The present disclosure can be applied to, in addition to mobile devices, such as smartphones, various types of equipment with a display, such as personal computers and image forming apparatuses.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. A display device comprising:
a display;
a touch panel that is disposed at a front of the display and detects whether or not the display has been touched and a point of touch on the display; and
a control unit that includes a processor and, based on operation of the processor in accordance with an operating program, accepts a scroll gesture on an image-displayed screen on which a screen image is displayed by the display, the scroll gesture being based on whether or not the display has been touched and the point of touch, which have been detected by the touch panel, and controls a display operation of the display,
wherein the control unit detects a pressure of touch on the display based on a signal output from the touch panel, determines a scroll speed based on the detected pressure of touch, and, upon acceptance of the scroll gesture, allows the display to display the screen image by scrolling at the determined scroll speed.

2. The display device according to claim 1, wherein the control unit decreases the scroll speed as the detected pressure of touch increases.

3. The display device according to claim 1, wherein the control unit calculates the scroll speed by multiplying a speed of change in the point of touch detected by the touch panel by a predetermined proportional constant and determines the scroll speed based on the pressure of touch by changing the proportional constant based on the detected pressure of touch.

4. The display device according to claim 1, wherein the control unit changes, based on the determined scroll speed, a manner of displaying a background of the image-displayed screen.

5. The display device according to claim 4, wherein the control unit changes the manner of displaying the background by giving noise to the background and increases an amount of the noise given to the background as the determined scroll speed decreases.

6. The display device according to claim 4, wherein the control unit changes the manner of displaying the background by changing a density of a color of the background and increases the density of the color as the determined scroll speed decreases.

7. The display device according to claim 1, wherein in the case where while the control unit allows the display to display the screen image by scrolling in a first direction, the control unit accepts a scroll gesture for displaying the screen image by scrolling in a second direction opposite to the first direction, the control unit allows the display to display the screen image by scrolling in the second direction at a lower scroll speed than a scroll speed specified by the scroll gesture.

8. The display device according to claim 7, wherein the control unit makes the manner of displaying the background during scrolling of the screen image in the second direction different from the manner of displaying the background during scrolling of the screen image in the first direction.

9. A computer-readable non-transitory recording medium with a display control program recorded thereon, the display control program allowing a computer to:
function as a controller that accepts a scroll gesture on an image-displayed screen on which a screen image is displayed by a display, the scroll gesture being based on whether or not the display has been touched and a point of touch on the display, which have been detected by a touch panel disposed at the front of the display, and controls a display operation of the display; and
further function so that the controller detects a pressure of touch on the display based on a signal output from the touch panel, determines a scroll speed based on the detected pressure of touch, and, upon acceptance of the scroll gesture, allows the display to display the screen image by scrolling at the determined scroll speed.
